(19) United States
(12) Patent Application Publication
(10) Pub. No.: US 2026/0210490 A1
(43) Pub. Date: Jul. 23, 2026

(54) Liquid Laundry Product Container Hanger

(71) Applicant: Dawn Patrice Tyrrell, West Plains, MO (US)

(72) Inventor: Dawn Patrice Tyrrell, West Plains, MO (US)

(21) Appl. No.: 19/033,674

(22) Filed: Jan. 22, 2025

(51) Int. Cl. F16M 13/02

(52) U.S. Cl. CPC F16M 13/022

(57) ABSTRACT

The liquid laundry product container hanger is made of fabric, accommodates any size container, and mounts the product container under common wire shelving at an angle. The product is now both easy to reach and at an angle allowing for faster and complete emptying so there is no wasted product.

### BACKGROUND

Many liquid laundry products are sold in a container designed to lay on its side and dispensed from a level shelf. This design lends to slow gravity dispensing and does not allow for complete emptying of the product purchased. Additionally, many laundry areas use common wire shelving mounted above the laundry machines making them difficult to reach. There are tilted platforms that support complete emptying of the product; however, these are designed to sit on a level surface and only exacerbate the problem of making it difficult reach.

### BRIEF SUMMARY

The liquid laundry product container hanger mounts the product container under the wire shelving at an angle. This design makes the product both easy to reach and allows for complete emptying so there is no wasted product. The angle allows for faster gravity dispensing of product. It is constructed out of fabric so it can mold to any sized side-lying container the consumer uses, includes a securement feature to keep the container in place, and hangs from the larger diameter wires of common wire shelving.

### DRAWINGS

FIG. 1 depicts the invention lying flat from an arial view.

FIG. 2 depicts the invention with a representative Container as it hangs.

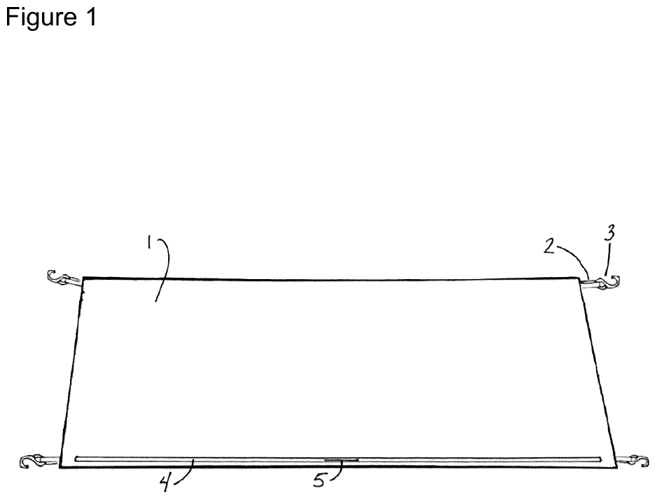

FIG. 1:
1. A double layer of fabric sewn together with the top and bottom edges along the grain and the left and right edges cut at a 10-degree angle.
2. A loop of narrow bias tape sewn into the seams at the four corners on the short edges.
3. An S-hook crimped onto each of the four loops.
4. A container securement of a length of narrow bias tape.
5. A center stitch line for container securement.

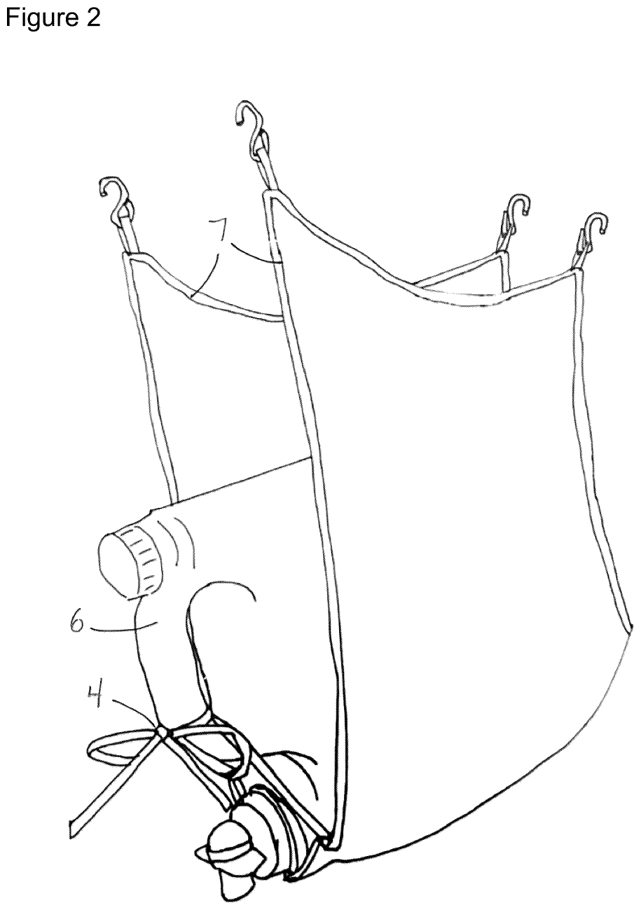

FIG. 2:
4. A length of container securement fed through the handle of the container and tied.
6. A representative container.
7. Topstitching of finished product.

### DETAILED DESCRIPTION

A single piece of fabric is cut to a rectangle of 32 inches by 22 inches along the grain. It is folded in half along the 32-inch length. From the point of the fold, the two short edges are cut to the long raw edge at a 10-degree angle. The fabric is opened and the raw edges are finished. Four 2-inch lengths of narrow double fold bias tape are cut, folded in half, and sewn to the right side of the fabric ¼-inch from the center fold line and ½-inch from the long raw edge. The fabric is folded, right sides together, along the center fold line and a narrow seam is stitched along the three raw edges, leaving a center opening along the long raw edge for turning. The corners are clipped. The fabric is turned right side out, pressed, and topstitched on all four edges closing the center opening. A 30-inch length of narrow double fold bias tape is cut, centered on the long edge along the topstitching, and stitched four inches at the center. One-inch S-hooks are inserted through the four loops from the outside toward the center and crimped in place. The open end of the S-hooks are opened slightly further to accommodate the larger diameter wires of common wire shelving. The invention is hooked onto the front and rear larger diameter wires under the shelf with the container securement inside the sling created at the front. The container is placed into the sling created with the container dispenser extending just beyond the front edge of the invention. The container securement lengths are fed through the center of the handle and wrapped to the outside front and tied in place.

1. A liquid laundry product container hanger (“Device”) made of fabric to hug any size container designed to lay on and be dispensed from a level surface.

2. A device made of fabric to compliment any décor.

3. A device made to hang below common wire shelving for ease of reach.

4. A device made to support a container at an angle for faster and complete emptying of product.
